(19) United States
(12) Patent Application Publication
(10) Pub. No.: US 2024/0152780 A1
(43) Pub. Date: May 9, 2024

(54) TRANSFORMER-BASED ARCHITECTURE FOR DENSITY RATIO ESTIMATION

(71) Applicant: Royal Bank of Canada, Toronto (CA)

(72) Inventors: Keyi Tang, Vancouver (CA); Yanshuai Cao, Toronto (CA)

(21) Appl. No.: 18/491,417

(22) Filed: Oct. 20, 2023

Related U.S. Application Data
(60) Provisional application No. 63/421,484, filed on Nov. 1, 2022.

(51) Int. Cl. G06N 5/022

(52) U.S. Cl. CPC G06N 5/022

(57) ABSTRACT

Methods, systems, and techniques for density ratio estimation of data that includes a covariate variable (W) and a treatment variable (T). The density ratio estimation may be performed using a transformer-based architecture, and the density ratio may be used to control confounding bias in the data. An electronic representation of the data is obtained. At first and second self-attention layers, respectively, covariate variable embeddings based on the data representing the covariate variable and treatment variable embeddings based on the data representing the treatment variable are determined. Cross-attention embeddings based on the covariate and treatment variable embeddings are then determined at a cross-attention layer. At a linear layer and based on the cross-attention embeddings, a density ratio is estimated. The self-attention layers, cross-attention layer, and linear layer are trained using a loss function that determines a loss between an output of the linear layer and the density ratio.

### CROSS-REFERENCE TO RELATED APPLICATION

The present application claims priority to U.S. provisional patent application No. 63/421,484 filed on Nov. 1, 2022, and entitled “Method and System for Debiasing Data”, the entirety of which is hereby incorporated by reference.

### TECHNICAL HELD

The present disclosure is directed at a transformer-based architecture for density ratio estimation, and at the use of that architecture for controlling confounding bias in data.

### BACKGROUND

There are a variety of systems in which a machine learning model, such as an artificial neural network, can be trained to make a causal inference from historical data. One challenge with doing this is that in some contexts, the historical data may be biased in some way. This can consequently lead to incorrect inferences.

For example, in respect of an algorithmic marketing system, the system may be configured to serve to an individual certain digital advertisements in response to that individual's past behavior (e.g., purchases made; ads clicked). However, that data describing past behavior may be biased by confounding factors such as non-digital advertising campaigns that that individual may have been concurrently exposed to. If the system makes a causal impact estimation based on a presumption that the individual's past behavior is solely attributable to the digital advertisement the system served to the individual, the causal impact estimation could very well be incorrect.

Consequently, in order to make an accurate causal impact estimation or causal prediction, the machine learning model should be trained to account for that bias.

### SUMMARY

According to a first aspect, there is provided a system for density ratio estimation of data comprising a covariate variable and a treatment variable, the system comprising: a first self-attention layer for receiving first embeddings representing the covariate variable and configured to learn a covariate representation and to output covariate variable embeddings; a second self-attention layer for receiving second embeddings representing the treatment variable and configured to learn a treatment representation and to output treatment variable embeddings; a cross-attention layer configured to receive the covariate variable embeddings and the treatment variable embeddings and to output cross-attention embeddings; and a linear layer configured to receive the cross-attention embeddings and to estimate a density ratio based on the covariate and treatment variables, wherein the self-attention layers, cross-attention layer, and linear layer are trained using a loss function that determines a loss between an output of the linear layer and the density ratio.

The density ratio may be a marginal-to-joint density ratio.

The loss function may comprise a positivity regularizer.

The loss function may comprise a least squares loss function.

The positivity regularizer may comprise a square activation function.

In a least squares formulation, the loss function may comprise

$$argmin \frac{1}{N} {\sum }_{i}^{N} {r}^{2} ( {W}_{i} , {T}_{i} ) - \frac{2}{{N}^{2}} {\sum }_{j}^{N} {\sum }_{i}^{N} r ( {W}_{i} , {T}_{j} ) + argmin {\vert \frac{1}{{N}^{2}} {\sum }_{j}^{N} {\sum }_{i}^{N} \frac{1}{r ( {W}_{i} , {T}_{j} )} - 1 \vert}^{2} ,$$

and N may be a number of data entries, W may be the covariate variable, T may be the treatment variable, and r may be the density ratio.

The loss function may comprise a KL-divergence loss function and the density ratio may be output from the linear layer in log scale. For example, the loss function may comprise

$$argmin {\vert log {\sum }_{j}^{N} {\sum }_{i}^{N} \frac{1}{r ( {W}_{i} , {T}_{j} )} - 2 log N \vert}^{2} ,$$

and N may be a number of data entries, W may be the covariate variable, T may be the treatment variable, and r may be the density ratio.

The loss function may comprise a multinomial logistic regression loss function. For example, the loss function may comprise

$$argmax \frac{1}{N} {\sum }_{i}^{N} [ log p ( C = 0 \vert {W}_{i} , {T}_{i} ) ] + \frac{1}{{N}^{2}} {\sum }_{i}^{N} {\sum }_{j}^{N} [ log p ( C = 1 \vert {W}_{i} , {T}_{j} ) ] ,$$

and N may be a number of data entries, W may be the covariate variable, T may be the treatment variable, and C=0 and C=1 may represent two classes for data points (W,T) that are sampled from p(W,T) and p(W)p(T), respectively.

The system may further comprise a data debiasing module configured to debias the data based on the density ratio.

At least one of the covariate variable embeddings or treatment variable embeddings may have more than ten dimensions.

A ratio of dimensions of the covariate variable embeddings to the treatment variable embeddings may be at least 10:1.

The density ratio may be estimated using a first transformer-based architecture, and the system may further comprise a second transformer-based architecture to evaluate a transformer-based response function, and terms comprising the density ratio and the transformer-based response function may be summed to result in a doubly robust causal estimator.

The doubly robust causal estimator may comprise

$$\frac{1}{N} {\sum }_{j}^{N} y ( {W}_{i} , {T}_{j} ) + \frac{p ( {W}_{i} )}{p ( {W}_{i} \vert {T}_{i} )} [ {Y}_{i} - y ( {W}_{i} , {T}_{i} ) ] ,$$

the first transformer-based architecture may be used to evaluate

$$\frac{p ( {W}_{i} )}{p ( {W}_{i} \vert {T}_{i} )} ,$$

the second transformer-based architecture may be used to evaluate y(Wᵢ,Tⱼ), with N being a number of data entries, W being the covariate variable, T being the treatment variable, y being the response function, and Yᵢ being a true outcome observed from sample i.

According to another aspect, there is provided a use of the above system to determine a personalized interest rate for financial products.

According to another aspect, there is provided a method for density ratio estimation of data comprising a covariate variable and a treatment variable, the method comprising: obtaining an electronic representation of the data, wherein the electronic representation comprises first and second embeddings respectively representing the covariate variable and the treatment variable; determining, at a first self-attention layer, covariate variable embeddings based on the first embeddings; determining, at a second self-attention layer, treatment variable embeddings based on the second embeddings; determining, at a cross-attention layer, cross-attention embeddings based on the covariate variable embeddings and treatment variable embeddings; and estimating, at a linear layer and based on the cross-attention embeddings, a density ratio based on the covariate and treatment variables, wherein the self-attention layers, cross-attention layer, and linear layer are trained using a loss function that determines a loss between an output of the linear layer and the density ratio.

The method may further comprise de-biasing the data using the density ratio.

The density ratio may be a marginal-to-joint density ratio, and the method may further comprise performing causal effect estimation using the de-biased data.

According to another aspect, there is provided the use of the system to perform algorithmic marketing; to implement a loyalty rewards program; to perform policy research; to perform medical or pharmaceutical research; and/or to determine personalized pricing for products or services.

According to another aspect, there is provided a non-transitory computer readable medium having stored thereon computer program code that is executable by a processor and that, when executed by the processor, causes the processor to perform the above method.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts an example transformer-based model architecture for density ratio estimation.

FIG. 2 depicts an example method for debiasing data using a density ratio estimation performed with the transformer-based model architecture of FIG. 1.

FIG. 3 depicts an example computer system that may be used to implement the transformer-based model architecture of FIG. 1 and the method of FIG. 2.

### DETAILED DESCRIPTION

At least some embodiments herein are applied to correct bias in data samples by reweighting those samples. Reweighting samples as described herein is technically beneficial in that those reweighted samples may be used to improve training of machine learning (ML) models, and the consequent causal inferences made by those trained models.

One application for better bias correction is for better evaluation of causal effect. In algorithmic marketing for example (recommendation, ad targeting, client targeting) (e.g., a loyalty rewards program), determining customized/personalized pricing for products or services (e.g., “smart” pricing in which a system may determine a personalized interest rate for financial products such as a GIC or a personalized mortgage rate), policy research, and medical or pharmaceutical research, a central need is to estimate the causal effect of treatment/decision/action. This is typically assessed via randomized control trials (i.e., A/B tests). However, it is often not possible, not cost-effective, or not possible to perform such randomized trials. An alternative is to make causal inferences from historical data, which data is often biased by the observation or selection process used to obtain that data when compared to randomized control trials. The methods and systems described herein are directed at improving bias correction, leading to a more accurate estimate of ideal live testing results based on historical data, which helps better decision-making.

From a technical perspective, this bias correction method can improve machine learning (ML) model training directly by reweighting training instances to match a desired unbiased distribution. For example, any existing model and decision rules running in production affect observational data collected from a user. A concrete use case is with recommender systems that affect both what is shown, and also indirectly, user behaviors. For example, an original recommender system may implement a behavior policy determined in respect of observed data. A subsequent new recommender system may implement a corresponding target policy, which accordingly changes the data distribution generated by users using the new recommender system compared to the data distribution used to determine the target policy. Learning algorithms and offline evaluation metrics should account for this distribution shift. This problem is known as off-policy learning. Additionally, reweighting may be applied not only to data samples used for training, but also data samples used for inference and evaluation.

### Probability Density Functions

Accurately estimating the ratio of two probability density functions has been demonstrated to be very useful in various tasks. For a causal inference task, debiasing the effect of a confounding variable comprises estimating marginal to joint density ratio of treatment variable T and confounding variable W: p(T)p(W)/p(T,W). As used herein, “debiasing” data comprises at least partially ameliorating confounding bias in data. For a machine learning task, domain adaptation with covariate shift comprises estimating the density ratio of features p_{T}(X)/p_{S}(X) between the source and target domains. For reinforcement learning, offline policy evaluation comprises estimating the density ratio between the target policy and the behavior policy: p_{T}(A|S)/p_{B}(A|S).

A naive approach to estimating the density ratio is to separately estimate the densities corresponding to the numerator and denominator of the ratio, and then take the ratio of the estimated densities. Such a method has been widely adopted in applications such as causal inference. However, this naive approach is not reliable, particularly in high-dimensional (i.e., any dimension larger than 5) problems, since division by an estimated quantity can magnify the estimation error [11]. To overcome this drawback, various approaches to directly estimating the density ratio without going through density estimation have been described [2, 3, 12, 13]. Theoretical analysis carried out in [5] has shown the direct estimation methods would outperform the other approaches in the absence of special prior knowledge.

Despite the early encouraging results from the direct density ratio estimators, the existing methods suffer from one or more following key weaknesses:
1. For marginal to joint density ratio p(T)p(W)/p(T,W) estimation, most methods lack the capability of modeling the nonlinear relationship between T and W particularly when the sizes of dimensions are very imbalanced.
2. Bad finite sample performance due to single direction density-ratio matching.
3. Poor flexibility to adapt to various types of input variables such as categorical features, time series, etc.
4. No direct control over the inductive bias of the overlap between two distributions in interest.

To address these weaknesses of existing density ratio estimators, at least some embodiments described herein are directed at an end-to-end transformer for estimating a density ratio. Additionally, described herein in respect of at least some embodiments is a positivity regularization that allows direct control of the overlap between two distributions.

### Marginal-to-Joint Density Ratio Estimation

The following describes implementation of a transformer that may be used to estimate a marginal-to-joint density ratio.

The density ratio (r) is transformed using the Bayesian rule:

$$\begin{matrix}r ( W , T = t ) = \frac{p ( W )}{p ( W \vert T = t )} \\ = \frac{p ( W ) p ( T = t )}{p ( W , T = t )}\end{matrix} \qquad ( 1 )$$

Different loss functions may be used in respect of different embodiments. Generally, the loss function determines a loss between an output of the transformer and the actual marginal-to-joint density ratio. The following describes three example loss functions based on 1) L2 (least-squares) loss, 2) KL-divergence, and 3) multinomial logistic regression.

When applying a least-squares formulation, unbiasing the marginal-to-joint density ratio can be derived by solving the least-squares optimization problem:

$$argmin {𝔼}_{p ( W , T )} [ {\vert r ( W , T ) - \frac{p ( W ) p ( T )}{p ( W , T )} \vert}^{2} ] = argmin {𝔼}_{p ( W , T )} [ {r}^{2} ( W , T ) - 2 \frac{r ( W , T ) p ( W ) p ( T )}{p ( W , T )} + \frac{{p}^{2} ( W ) {p}^{2} ( T )}{{p}^{2} ( W , T )} ] \qquad ( 2 )$$

Since the last term is irrelevant to density ratio r(W,T), it can be removed from the target:

$$argmin {𝔼}_{p ( W , T )} [ {r}^{2} ( W , T ) - 2 \frac{r ( W , T ) p ( W ) p ( T )}{p ( W , T )} ] = argmin {𝔼}_{p ( W , T )} [ {r}^{2} ( W , T ) ] - 2 {𝔼}_{p ( T )} [ {𝔼}_{p ( W )} [ r ( W , T ) ] ] \approx argmin \frac{1}{N} {\sum }_{i}^{N} {r}^{2} ( {W}_{i} , {T}_{i} ) - \frac{2}{{N}^{2}} {\sum }_{j}^{N} {\sum }_{i}^{N} r ( {W}_{i} , {T}_{j} ) \qquad ( 3 )$$

where N is the number of entries in the dataset.

Without limiting the model capacity, this loss function can be arbitrarily small due to the counterfactual density ratio appearing in the second term. Thus a constraint to regularize the positivity of the density ratio model is added:

$$argmin {\vert {𝔼}_{p ( T )} [ {𝔼}_{p ( W )} [ \frac{1}{r ( W , T )} ] ] - 1 \vert}^{2} \approx argmin {\vert \frac{1}{{N}^{2}} {\sum }_{j}^{N} {\sum }_{i}^{N} \frac{1}{r ( {W}_{i} , {T}_{j} )} - 1 \vert}^{2} \qquad ( 4 )$$

The smaller the output of Equation (4) is, the larger the overlap between the two distributions.

In view of the above, when applying least-squares, a transformer based deep learning (DL) model is used to approximate the density ratio r(W,T) directly.

When applying a KL-divergence formulation, Equation (5) applies:

$$argmin {D}_{KL} [ p ( W , T ) \vert \vert \frac{p ( W ) p ( T )}{p ( W , T )} ] = argmin {𝔼}_{p ( W , T )} [ log [ \frac{r ( W , T ) p ( W , T )}{p ( W ) p ( T )} ] ] = argmin {𝔼}_{p ( W , T )} [ log [ r ( W , T ) ] ] \approx argmin \frac{1}{N} {\sum }_{i}^{N} [ log [ r ( {W}_{i} , {T}_{i} ) ] ] \qquad ( 5 )$$

The solution is subject to the same constraints of Equation (4). For numerical stability, the soft constraints are enforced in log space:

$$argmin {\vert log {\sum }_{j}^{N} {\sum }_{i}^{N} \frac{1}{r ( {W}_{i} , {T}_{j} )} - 2 log N \vert}^{2} \qquad ( 6 )$$

In view of the above, when applying a KL-divergence formulation a transformer based DL model is used to approximate the density ratio in log scale log[r(W,T)].

Equation (7), which follows, is a loss function in respect of multinomial logistic regression formulation:

$$argmax p ( C = 0 ) {𝔼}_{p ( W , T )} [ log p ( C = 0 \vert W , T ) ] + p ( C = 1 ) {𝔼}_{p ( W ) p ( T )} [ log p ( C = 1 \vert W , T ) ] \approx argmax \frac{1}{N} {\sum }_{i}^{N} [ log p ( C = 0 \vert {W}_{i} , {T}_{i} ) ] + \frac{1}{{N}^{2}} {\sum }_{i}^{N} {\sum }_{j}^{N} [ log p ( C = 1 \vert {W}_{i} , {T}_{j} ) ] \qquad ( 7 )$$

where C=0 and C=1 represent two classes for data points (W,T) that are sampled from the joint distribution p(W,T) and the marginal distribution p(W)p(T), respectively. In multinomial logistic regression, a transformer-based DL model is used to approximate the conditional probability p(C|W,T)=softmax(h_{c}(W,T)) such that the target density ratio (in log space) can be derived by log r(W,T)=h₁(W,T)−h₀(W,T), where h(W,T) represents model output.

### Transformer-Based Model Architecture

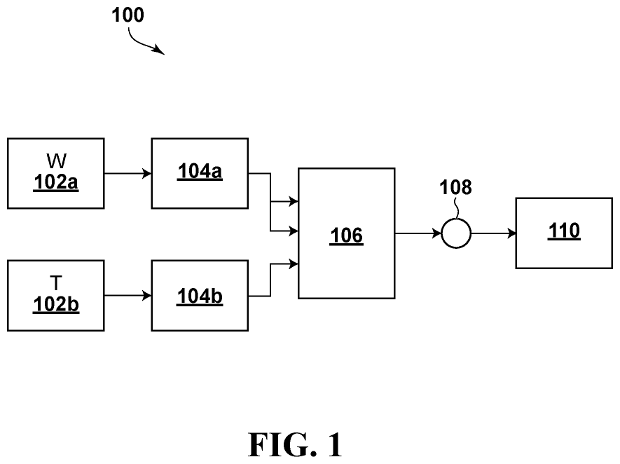

FIG. 1 depicts an example transformer-based model architecture 100 for debiasing data. As shown in FIG. 1, self-attention on covariates W and treatment variable T, respectively represented as first and second embeddings 102a,b, is applied by a first self-attention layer 104a (in respect of the first embeddings 102a) and a second self-attention layer 104b (in respect of the second embeddings 102b) separately to learn the covariates and treatment representation. An encoder (not shown) may be used to generate the first and second embeddings 102a,b from electronic representations of the covariates W and treatment variable T. The self-attention layers 104a,b respectively output embeddings (“covariate variable embeddings” and “treatment variable embeddings”) for the covariates W and treatment T. Then, a cross-attention layer 106 receives the outputs of the first and second self-attention layers 104a,b to directly model the interactions between the covariates and treatment variable. The outputs of the cross-attention layer 106, which are embeddings for the density ratio (“cross-attention embeddings”), are fed into a linear layer 108 to generate the final density ratio. In a least-squares formulation, a square activation function is added on top of the model output to force the density ratio to be a non-negative value, while in a KL-divergence formulation, the model output is taken as the density ratio in log scale. The density ratio may subsequently be input to a data debiasing module 110 from which the data may be debiased, such as by reweighting data samples in accordance with the density ratio, for use in training, inference, and/or evaluation.

A transformer model in isolation has very good modeling capacity and is capable of processing unbalanced dimensions. However, it may lead to positivity issues in high dimensional space. To address this, in at least some embodiments positivity regularizations such as those expressed in Equations (6) and (8) are used in conjunction with a transformer to permit density ratio estimation as described herein. This is technically advantageous over prior art solutions for density ratio estimation, such as applying a low capacity ML model (e.g., kernel machines), which may lead to poor performance on complex density ratio functions in high dimensional space (e.g., more than 10 dimensions). For example, a kernel machine may perform poorly if the dimension sizes of the treatment and covariate variables are unbalanced. This is because unlike a multilayer perceptron or kernel machine in which the first and second embeddings 102a,b are concatenated into a single vector, the cross-attention layer 106 explicitly models the interaction between the covariates W and treatment variable T, thus preventing one high-dimensional variable from overwhelming the other. For example, typically T has fewer than 5 dimensions while W may have an arbitrarily large number of dimensions. Regardless, when the ratio of W's dimensions to T's dimensions exceeds 10:1, the architecture of FIG. 1 helps to prevent W from overwhelming T.

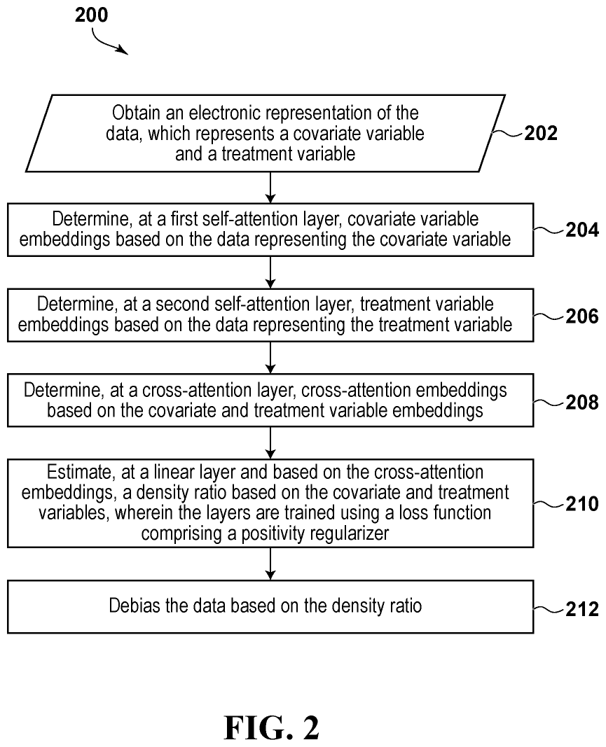

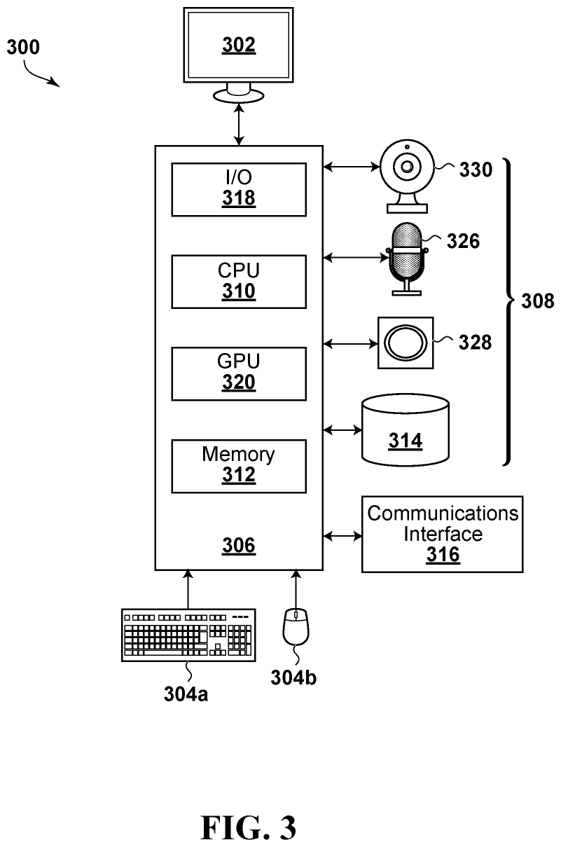

FIG. 2 depicts an example method 200 for debiasing data that applies the transformer-based architecture of FIG. 1, in which training was performed using a loss function comprising a positivity regularizer, as discussed above. The method 200 of FIG. 2, and the related architecture 100 and training, may be implemented using the computer system 300 of FIG. 3 as described below. For example, the method 200 of FIG. 2 and the architecture 100 of FIG. 1 may be implemented as computer program code, stored on a non-transitory computer readable medium such as a memory 312 (depicted in FIG. 3), and executed by one or more of the CPU 310 and GPU 320 (both depicted in FIG. 3).

The method 200 commences at block 202, where an electronic representation of the data to be debiased is obtained, such as from a database storing the data. This data is encoded into the first and second embeddings 102a,b that are input to the transformer. The data may have been collected from a system for performing algorithmic marketing, policy research, medical or pharmaceutical research, or for determining personalized pricing for certain products or services, for example. As described above, the data represents a treatment variable and a confounding covariate variable.

At block 204, the method 200 comprises determining, at the first self-attention layer 104a, covariate variable embeddings based on the data representing the covariate variable. Analogously, at block 206, the method 200 comprises determining, at the second self-attention layer 104b, treatment variable embeddings based on the data representing the treatment variable. Subsequent to the processing by the first and second self-attention layers 104a,b, at block 208 the method 200 comprises determining, at the cross-attention layer 106, cross-attention embeddings based on the covariate variable embeddings and treatment variable embeddings. At block 210, the method 200 comprises estimating, at the linear layer 108 and based on the cross-attention embeddings, a density ratio based on the covariate and treatment variables. Training of the architecture 100, which in FIG. 1 comprises the self-attention layers 104a,b, cross-attention layer 106, and linear layer 108 are trained using a loss function comprising a positivity regularizer prior to being used to estimate the density ratio. After the density ratio is estimated, the method 200 comprises debiasing the data based on the density ratio, such as in the data debiasing module 110 mentioned above. This may comprise reweighting samples, used for one or more of training, inference, and evaluation, based on the estimated density ratio. The debiased data and/or the density ratio may be stored for future use, such as in a database. A causal inference may subsequently be made on the debiased data.

### Density Ratio Estimation in General

Similar to the marginal-to-joint density ratio estimator described above, any density ratio function may be estimated using the least-squares formulation and KL-divergence formulation by replacing p(W|T) with a different distribution.

### Density Ratio Estimation for Causal Inference

Equation (8) is directed at a doubly robust causal estimator:

$$𝔼 [ Y \vert do ( T = {t}_{i} ) ] = {𝔼}_{p ( W )} [ {𝔼}_{p ( Y \vert W , T )} [ Y \vert W , T = {t}_{i} ] ] + {𝔼}_{p ( W \vert T )} [ \frac{p ( W )}{p ( W \vert T )} [ Y - {𝔼}_{p ( Y \vert W , T )} [ Y \vert W , T = {t}_{i} ] ] ] \approx \frac{1}{N} {\sum }_{j}^{N} y ( {W}_{i} , {T}_{j} ) + \frac{p ( {W}_{i} )}{p ( {W}_{i} \vert {T}_{i} )} [ {Y}_{i} - y ( {W}_{i} , {T}_{i} ) ] \qquad ( 8 )$$

There are two key components in the doubly robust causal estimator: a response function y(W,T) and a density ratio function

$$\frac{p ( W )}{p ( W \vert T )} .$$

In Equation (8), Yᵢ is the true outcome observed from sample i. A transformer-based response function y(W,T) is built following the adversarial training method described in [14].

The density ratio

$$\frac{p ( W )}{p ( W \vert T )}$$

is estimated with the transformer-based density ratio estimator described above. In respect of implementation, the architecture 100 of FIG. 1 may be used to estimate the density ratio, another transformer-based architecture may be used to estimate the response function y(W,T), thereby permitting all terms of Equation (8) to be estimated and the result of Equation (8) to be estimated by summing the terms.

Once the response function and density ratio function are determined, following [6], the regression-based doubly robust method is applied to generate a final interventional outcome.

### Experiments

The above method was tested against the state-of-art causal effect estimators [8-10] on two widely-used benchmark datasets: IHDP [4] and News [7]. Following [1, 8], a semi-synthetic data generator with a continuous treatment variable was used for both datasets. Each dataset was randomly divided into a training set (67%) and a testing set (33%). As shown in Table 1, the above method outperformed all the baselines on both datasets. On the IHDP dataset, the above method outperformed the baseline by a large margin. In Table 1, for both datasets the table shows the root mean squared error of the average response dosage curve. TR means the targeted regularization method introduced in [10].

TABLE 1
Experimental results on two synthetic datasets

| | IHDP | News |
|---|---|---|
| DragonNet | 0.350 ± 0.016 | 0.180 ± 0.0081 |
| [10] | | |
| DragonNet + | 0.208 ± 0.0072 | 0.149 ± 0.0051 |
| TR | | |
| DRNet [9] | 0.316 ± 0.016 | 0.183 ± 0.0084 |
| DRNet + TR | 0.230 ± 0.0086 | 0.114 ± 0.0041 |
| VcNet [8] | 0.189 ± 0.013 | 0.028 ± 0.0011 |
| VcNet + TR | 0.117 ± 0.0085 | 0.024 ± 0.0009 |
| Example | 0.022 ± 0.0185 | 0.022 ± 0.0145 |
| architecture | | |
| 100 | | |

An example computer system in respect of which the transformer-based architecture described above may be implemented is presented as a block diagram in FIG. 3. The example computer system is denoted generally by reference numeral 300 and includes a display 302, input devices in the form of keyboard 304a and pointing device 304b, computer 306 and external devices 308. While pointing device 304b is depicted as a mouse, it will be appreciated that other types of pointing device, or a touch screen, may also be used.

The computer 306 may contain one or more processors or microprocessors, such as a central processing unit (CPU) 310. The CPU 310 performs arithmetic calculations and control functions to execute software stored in a non-transitory internal memory 312, preferably random access memory (RAM) and/or read only memory (ROM), and possibly additional memory 314. The additional memory 314 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 314 may be physically internal to the computer 306, or external as shown in FIG. 3, or both. The additional memory 314 may also comprise a database for storing training data or data to be used for inference after training. For example, the datasets used in the experiments described above may be stored in such a database and retrieved for use in training.

The one or more processors or microprocessors may comprise any suitable processing unit such as an artificial intelligence accelerator, programmable logic controller, a microcontroller (which comprises both a processing unit and a non-transitory computer readable medium), AI accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above, such as the method 200 of FIG. 2, may be implemented as computer program code and stored in the internal and/or additional memory 314 for execution by the one or more processors or microprocessors to effect neural network pre-training, training, or use of a trained network for inference.

The computer system 300 may also include other similar means for allowing computer programs or other instructions to be loaded. Such means can include, for example, a communications interface 316 which allows software and data to be transferred between the computer system 300 and external systems and networks. Examples of communications interface 316 can include a modem, a network interface such as an Ethernet card, a wireless communication interface, or a serial or parallel communications port. Software and data transferred via communications interface 316 are in the form of signals which can be electronic, acoustic, electromagnetic, optical or other signals capable of being received by communications interface 316. Multiple interfaces, of course, can be provided on a single computer system 300.

Input and output to and from the computer 306 is administered by the input/output (I/O) interface 318. This I/O interface 318 administers control of the display 302, keyboard 304A, external devices 308 and other such components of the computer system 300. The computer 306 also includes a graphical processing unit (GPU) 320. The latter may also be used for computational purposes as an adjunct to, or instead of, the (CPU) 310, for mathematical calculations.

The external devices 308 include a microphone 326, a speaker 328 and a camera 330. Although shown as external devices, they may alternatively be built in as part of the hardware of the computer system 300. For example, the camera 330 and microphone 326 may be used to obtain data to be used for training and/or inference in respect of the architecture 100.

The various components of the computer system 300 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Phrases such as “at least one of A, B, and C”, “at least one of A, B, or C”, “one or more of A, B, and C”, and “A, B, and/or C” are intended to include both a single item from the enumerated list of items (i.e., only A, only B, or only C) and multiple items from the list (i.e., A and B, B and C, A and C, and A, B, and C). Accordingly, the phrases “at least one of”, “one or more of”, and similar phrases when used in conjunction with a list are not meant to require that each item of the list be present, although each item of the list may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

### LIST OF REFERENCES

The following is a list of the references referred to above, each of which is hereby incorporated by reference.
[1] Ioana Bica, James Jordon, and Mihaela van der Schaar. Estimating the effects of continuous-valued interventions using generative adversarial networks. Advances in Neural Information Processing Systems, 33:16434-16445, 2020.
[2] Kristy Choi, Madeline Liao, and Stefano Ermon. Featurized density ratio estimation. In Uncertainty in Artificial Intelligence, pages 172-182. PMLR, 2021.
[3] Arthur Gretton, Alex Smola, Jiayuan Huang, Marcel Schmittfull, Karsten Borgwardt, and Bernhard Schölkopf. Covariate shift by kernel mean matching. Dataset shift in machine learning, 3(4):5, 2009.
[4] Jennifer L Hill. Bayesian nonparametric modeling for causal inference. Journal of Computational and Graphical Statistics, 20(1):217-240, 2011.
[5] Takafumi Kanamori, Taiji Suzuki, and Masashi Sugiyama. Theoretical analysis of density ratio estimation. IEICE transactions on fundamentals of electronics, communications and computer sciences, 93(4):787-798, 2010.
[6] Edward H Kennedy, Zongming Ma, Matthew D McHugh, and Dylan S Small. Non-parametric methods for doubly robust estimation of continuous treatment effects. Journal of the Royal Statistical Society: Series B (Statistical Methodology), 79(4):1229-1245, 2017.
[7] Newman, David. (2008). Bag of Words. UCI Machine Learning Repository. https://doi.org/10.24432/C5ZG6P.
[8] Lizhen Nie, Mao Ye, Qiang Liu, and Dan Nicolae. Vcnet and functional targeted regularization for learning causal effects of continuous treatments. arXiv preprint arXiv:2103.07861, 2021.
[9] Patrick Schwab, Lorenz Linhardt, Stefan Bauer, Joachim M Buhmann, and Walter Karlen. Learning counterfactual representations for estimating individual dose-response curves. In Proceedings of the AAAI Conference on Artificial Intelligence, volume 34, pages 5612-5619, 2020.
[10] Claudia Shi, David Blei, and Victor Veitch. Adapting neural networks for the estimation of treatment effects. Advances in neural information processing systems, volume 32, 2019.
[11] Sugiyama, M. & Suzuki, T. & Kanamori, Takafumi. (2010). Density Ratio Estimation: A Comprehensive Review. RIMS Kokyuroku. 10-31.
[12] Masashi Sugiyama, Taiji Suzuki, Shinichi Nakajima, Hisashi Kashima, Paul von Bünau, and Motoaki Kawanabe. Direct importance estimation for covariate shift adaptation. Annals of the Institute of Statistical Mathematics, 60(4):699-746, 2008.
[13] Makoto Yamada and Masashi Sugiyama. Direct importance estimation with gaussian mixture models. IEICE transactions on information and systems, 92(10):2159-2162, 2009.
[14] Yi-Fan Zhang, Hanlin Zhang, Zachary C. Lipton, Li Erran Li, and Eric P. Xing. Can transformers be strong treatment effect estimators? arXiv preprint arXiv:2202.01336v3 [cs.LG], 2022.

1. A system for density ratio estimation of data comprising a covariate variable and a treatment variable, the system comprising:
(a) a first self-attention layer for receiving first embeddings representing the covariate variable and configured to learn a covariate representation and to output covariate variable embeddings;
(b) a second self-attention layer for receiving second embeddings representing the treatment variable and configured to learn a treatment representation and to output treatment variable embeddings;
(c) a cross-attention layer configured to receive the covariate variable embeddings and the treatment variable embeddings and to output cross-attention embeddings; and
(d) a linear layer configured to receive the cross-attention embeddings and to estimate a density ratio based on the covariate and treatment variables, wherein the self-attention layers, cross-attention layer, and linear layer are trained using a loss function that determines a loss between an output of the linear layer and the density ratio.

2. The system of claim 1, wherein the density ratio is a marginal-to-joint density ratio.

3. The system of claim 2, wherein the loss function comprises a positivity regularizer.

4. The system of claim 3, wherein the loss function comprises a least squares loss function.

5. The system of claim 4, wherein the positivity regularizer comprises a square activation function.

6. The system of claim 5, wherein the loss function comprises
$$argmin \frac{1}{N} {\sum }_{i}^{N} {r}^{2} ( {W}_{i} , {T}_{i} ) - \frac{2}{{N}^{2}} {\sum }_{j}^{N} {\sum }_{i}^{N} r ( {W}_{i} , {T}_{j} ) + argmin {\vert \frac{1}{{N}^{2}} {\sum }_{j}^{N} {\sum }_{i}^{N} \frac{1}{r ( {W}_{i} , {T}_{j} )} - 1 \vert}^{2} ,$$
wherein N is a number of data entries, W is the covariate variable, T is the treatment variable, and r is the density ratio.

7. The system of claim 2, wherein the loss function comprises a KL-divergence loss function and wherein the density ratio is output from the linear layer in log scale.

8. The system of claim 7, wherein the loss function comprises
$$argmin {\vert log {\sum }_{j}^{N} {\sum }_{i}^{N} \frac{1}{r ( {W}_{i} , {T}_{j} )} - 2 log N \vert}^{2} ,$$
wherein N is a number of data entries, W is the covariate variable, T is the treatment variable, and r is the density ratio.

9. The system of claim 1, wherein the loss function comprises a multinomial logistic regression loss function.

10. The system of claim 9, wherein the loss function comprises
$$argmax \frac{1}{N} {\sum }_{i}^{N} [ log p ( C = 0 \vert {W}_{i} , {T}_{i} ) ] + \frac{1}{{N}^{2}} {\sum }_{i}^{N} {\sum }_{j}^{N} [ log p ( C = 1 \vert {W}_{i} , {T}_{j} ) ] ,$$
wherein N is a number of data entries, W is the covariate variable, T is the treatment variable, and C=0 and C=1 represent two classes for data points (W,T) that are sampled from p(W,T) and p(W)p(T), respectively.

11. The system of claim 1, further comprising a data debiasing module configured to debias the data based on the density ratio.

12. The system of claim 1, wherein at least one of the covariate variable embeddings or treatment variable embeddings have more than ten dimensions.

13. The system of claim 1, wherein a ratio of dimensions of the covariate variable embeddings to the treatment variable embeddings is at least 10:1.

14. The system of claim 1, wherein the density ratio is estimated using a first transformer-based architecture, and wherein the system further comprises a second transformer-based architecture to evaluate a transformer-based response function, and wherein terms comprising the density ratio and the transformer-based response function are summed to result in a doubly robust causal estimator.

15. The system of claim 14, wherein the doubly robust causal estimator comprises
$$\frac{1}{N} {\sum }_{j}^{N} y ( {W}_{i} , {T}_{j} ) + \frac{p ( {W}_{i} )}{p ( {W}_{i} \vert {T}_{i} )} [ {Y}_{i} - y ( {W}_{i} , {T}_{i} ) ] ,$$
wherein the first transformer-based architecture is used to evaluate
$$\frac{p ( {W}_{i} )}{p ( {W}_{i} \vert {T}_{i} )} ,$$
wherein the second transformer-based architecture is used to evaluate y(Wᵢ,Tⱼ), and wherein N is a number of data entries, W is the covariate variable, T is the treatment variable, y is the response function, and Yᵢ is a true outcome observed from sample i.

16. Use of the system of claim 1 to determine a personalized interest rate for financial products.

17. A method for density ratio estimation of data comprising a covariate variable and a treatment variable, the method comprising:
(a) obtaining an electronic representation of the data, wherein the electronic representation comprises first and second embeddings respectively representing the covariate variable and the treatment variable;
(b) determining, at a first self-attention layer, covariate variable embeddings based on the first embeddings;
(c) determining, at a second self-attention layer, treatment variable embeddings based on the second embeddings;
(d) determining, at a cross-attention layer, cross-attention embeddings based on the covariate variable embeddings and treatment variable embeddings; and
(e) estimating, at a linear layer and based on the cross-attention embeddings, a density ratio based on the covariate and treatment variables, wherein the self-attention layers, cross-attention layer, and linear layer are trained using a loss function that determines a loss between an output of the linear layer and the density ratio.

18. The method of claim 17, further comprising de-biasing the data using the density ratio.

19. The method of claim 18, wherein the density ratio is a marginal-to-joint density ratio, and wherein the method further comprises performing causal effect estimation using the de-biased data.

20. A non-transitory computer readable medium having stored thereon computer code that is executable by at least one processor and that, when executed by the at least one processor, causes the at least one processor to perform a method for density ratio estimation of data comprising a covariate variable and a treatment variable, the method comprising:
(a) obtaining an electronic representation of the data;
(b) determining, at a first self-attention layer, covariate variable embeddings based on the data representing the covariate variable;
(c) determining, at a second self-attention layer, treatment variable embeddings based on the data representing the treatment variable;
(d) determining, at a cross-attention layer, cross-attention embeddings based on the covariate variable embeddings and treatment variable embeddings; and
(e) estimating, at a linear layer and based on the cross-attention embeddings, a density ratio based on the covariate and treatment variables, wherein the self-attention layers, cross-attention layer, and linear layer are trained using a loss function that determines a loss between an output of the linear layer and the density ratio.
